(19) United States
(12) Patent Application Publication
(10) Pub. No.: US 2012/0024925 A1
(43) Pub. Date: Feb. 2, 2012

(54) Device for holding used dog waste bags

(76) Inventors: Sherry Caldeira, Franklin, MA (US); Theresa McClure, Franklin, MA (US)

(21) Appl. No.: 13/136,412

(22) Filed: Aug. 1, 2011

Related U.S. Application Data
(60) Provisional application No. 61/400,639, filed on Jul. 30, 2010.

(51) Int. Cl. A01K 29/00; B23P 11/00; A01K 27/00; B65B 67/12

(52) U.S. Cl. 224/576; 248/95; 29/428

(57) ABSTRACT

A device for holding used dog waste bags includes first and second ends that are connected by an intermediate section of reduced thickness. The first end includes a bag retainer in the form of an enlarged projection, the projection including a pair of bisecting linear slots. The slots are immediately defined by a plurality of flexible triangular fingers that frictionally engage used dog waste bags that are partially inserted through the linear slots. The second end is in the form of an enlarged ring shaped to define a circular opening. By wrapping the intermediate section around a leash and fittingly inserting the projection through the opening, the device forms a closed loop in securement around the leash. With the device clipped to the leash, used dog waste bags can be removably secured to the bag retainer to enable a dog walker to transport the used bags in a hands-free manner.

### CROSS-REFERENCE TO RELATED APPLICATIONS

The present application claims the benefit of U.S. Provisional Patent Application Ser. No. 61/400,639, which was filed on Jul. 30, 2010 in the names of Sherry Caldeira and Theresa McClure, the disclosure of which is incorporated herein by reference.

### BACKGROUND

The present invention relates generally to pet accessories and more particularly to devices that are used to facilitate the collection and disposal of solid dog waste.

The presence of uncollected dog waste in both public and private settings is typically considered unpleasant, obtrusive and highly undesirable. Accordingly, dog walkers are typically under a legal and/or moral obligation to routinely collect the solid waste left from their dogs and, in turn, dispose of the waste in a commonly accepted manner.

Dog waste bags are well known in the art and are commonly utilized to facilitate the collection and disposal of dog waste. Traditionally, a dog waste bag is generally in the form of a rectangular pouch that is open at one end, the bag being preferably constructed of a thin, biodegradable and/or flushable material for environmental purposes. As defined herein, dog waste bags represent both bags that are specifically designed for the collection and disposal of dog waste as well as similarly constructed bags that are designed for alternative purposes, such as plastic grocery and shopping bags.

In use, dog excrement is inserted into a dog waste bag through its open end. With the waste inserted, the open end of the bag is then enclosed (e.g., by tying the end into a knot) to secure the waste therein. Retained as such, the person walking the dog is then carries the enclosed bag to an appropriate location for disposal (e.g., a trash receptacle). During the transport period, the dog walker typically holds the used dog waste bag in one hand and the handle for the leash attached to the dog in the other hand.

Although well known in the art, the aforementioned method of disposing dog waste using one or more conventional dog waste bags suffers from a couple notable shortcomings.

As a first drawback, the aforementioned method often requires an individual to transport a used dog waste bag a considerable distance until such time that the bag can be discarded. Since both hands for the walker are typically required to handle the dog leash and the used dog waste bag, it has been found to be rather difficult for the dog walker to perform additional tasks during the transport period, such as operate a cellular telephone or access keys, which is highly undesirable.

As a second drawback, the aforementioned method requires an individual to directly handle a used dog waste bag for a prolonged period of time. As such, walkers often find the direct handling of a used dog waste bag for an extended length of time to be both unsanitary and unpleasant in nature.

### SUMMARY OF THE INVENTION

It is an object of the present invention to provide a new and improved device for holding used dog waste bags.

It is another object of the present invention to provide a device for holding used dog waste bags that, in combination with a leash, can be held using a single hand.

It is still another object of the present invention to provide a device for holding used dog waste bags of the type as described above which includes a limited number of parts, which is easy to use, which is durable in nature and which is inexpensive to manufacture.

Accordingly, there is provided a device for holding a used dog waste bag, the device comprising (a) a first end, the first end including a bag retainer adapted to hold the used dog waste bag, (b) a second end shaped to define an opening, and (c) an intermediate section connecting the first and second ends, (d) wherein the second end is adapted to be releasably secured to the first end to form a closed loop with at least a portion of the bag retainer disposed in alignment within the opening in the second end.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate an embodiment of the present invention and, together with the description, serve to explain the principles of the invention. In the drawings, wherein like reference numerals represent like parts:

FIG. 1(a) is a top perspective view of a device for holding used dog waste bags, the device being constructed according to the teachings of the present invention;

FIG. 1(b) is a rear view of the device shown in FIG. 1(a);

FIG. 1(c) is a top view of the device shown in FIG. 1(a);

FIG. 1(d) is a section view of the device shown in FIG. 1(c) taken along lines A-A;

FIG. 1(e) is a right end view of the device shown in FIG. 1(a);

FIGS. 2(a)-(c) are a series of top perspective views of the device shown in FIG. 1(a); the device being shown at various stages during the process of its mounting onto the handle of a retractable leash and its subsequent use in holding a dog waste bag;

FIGS. 3(a)-(d) are front perspective, top, right end and front views, respectively, of a clip for use in conjunction with the device shown in FIG. 1(a);

FIGS. 4(a) and 4(b) are exploded front perspective and assembled front perspective views, respectively, of the clip of FIG. 3(a) and the device of FIG. 1(a);

FIG. 5(a) is a perspective view of the device shown in FIG. 1(a) being secured to the loop handle of a ribbon-style leash; and

FIG. 5(b) is a perspective view of the clip in FIG. 3(a) securing the device shown in FIG. 1(a) at a fixed intermediate location on a ribbon-style leash.

### DETAILED DESCRIPTION

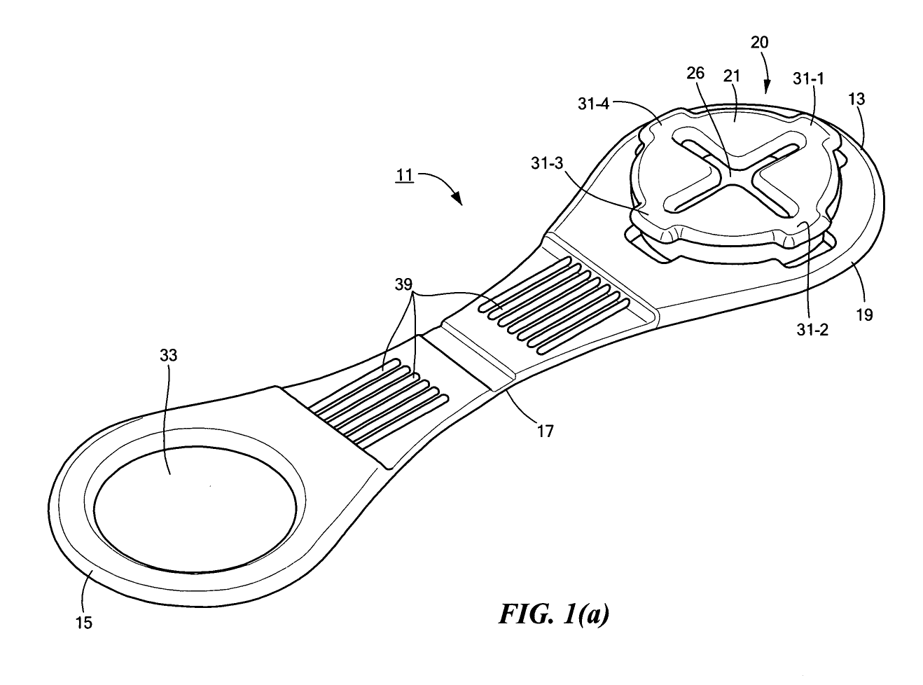

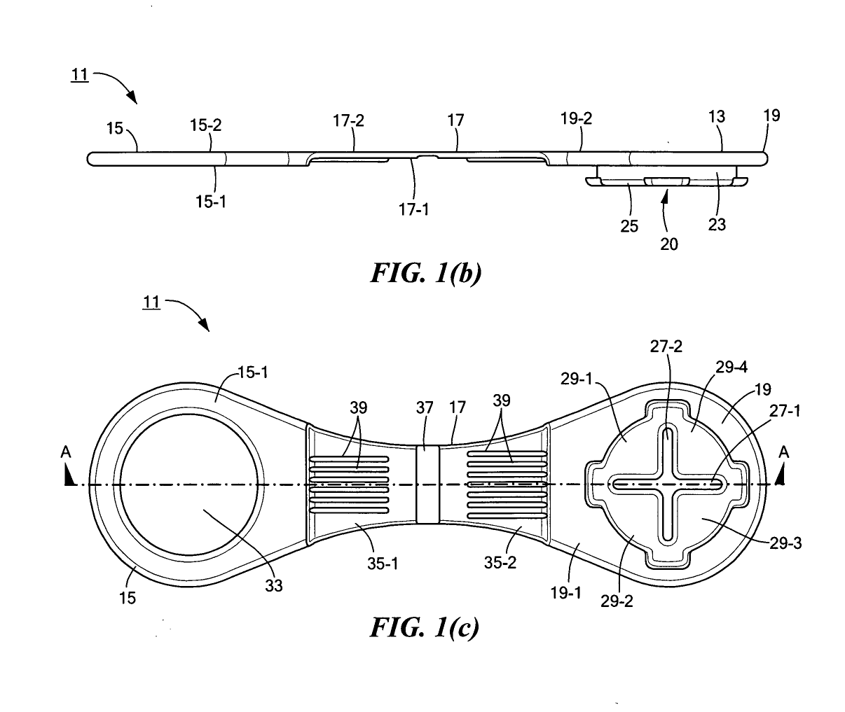

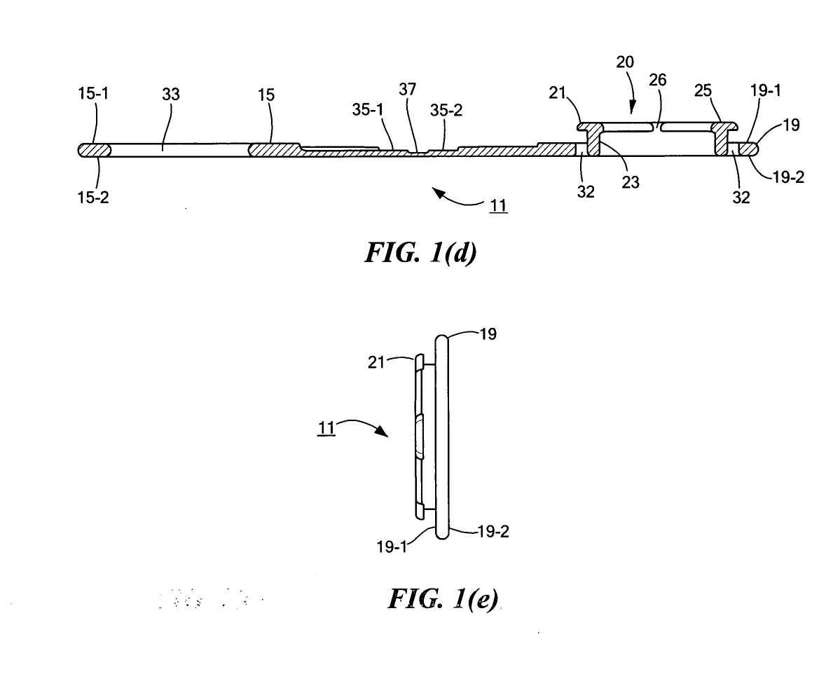

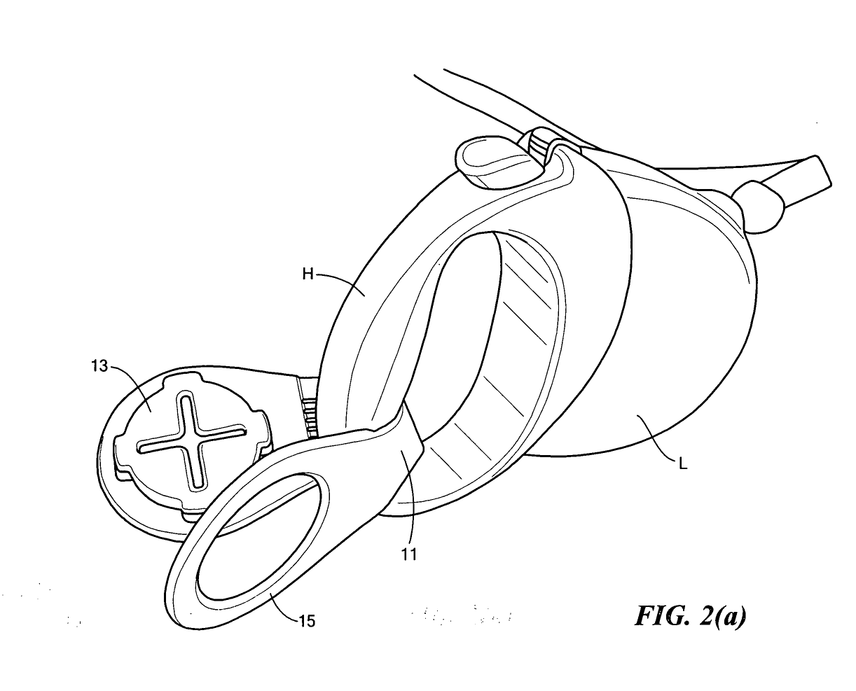

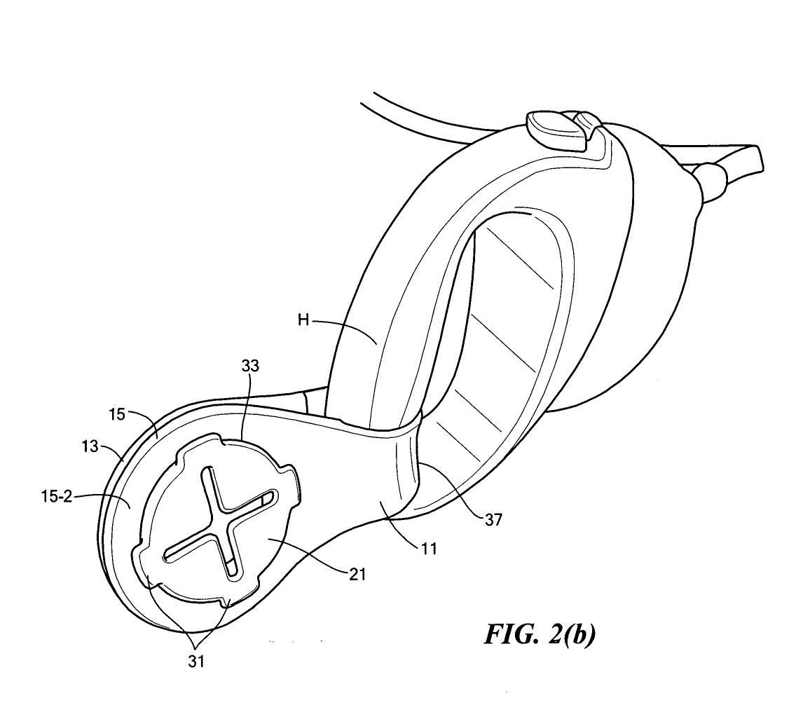

Referring now to FIGS. 1(a)-(e), there is shown a device for holding one or more used dog waste bags, the device being constructed according to the teachings of the present invention rand identified generally by reference numeral 11. As will be described further in detail below, device 11 is designed to be releasably retained onto a dog leash and, in turn, to hold one or more used dog waste bags, thereby limiting the number of items that a dog walker needs to carry by hand at any particular time, which is highly desirable.

Device 11 is preferably in the form of a thin, unitary strip of material approximately 8.5 inches in length that is preferably constructed out of a thermoplastic rubber (TPR) or other similar material using conventional molding techniques. As can be seen, device 11 comprises a first end 13, a second end 15 and a flexible intermediary section 17 connecting first end 13 and second end 15. As will be described in detail below, device 11 is designed to be folded about itself through intermediary section 17 and releasably secured together at first and second ends 13 and 15, thereby enabling device 11 to be hung on or otherwise secured to an object, such as a leash.

First end 13 of device 11 includes a generally rounded support surface, or base, 19 that includes a substantially flat inner surface 19-1 and a substantially flat outer surface 19-2, base 19 being approximately 2.5 inches in diameter and approximately 0.15 inches in thickness. First end 13 additionally includes a bag retainer 20 formed base 19. As will be described in detail below, bag retainer 20 is designed to releasably retain one or more used pet waste bags.

In the present invention, bag retainer 20 is represented as an enlarged projection 21 that protrudes up from flat inner surface 19-1 approximately 0.17 inches. As can be seen most clearly in FIG. 1(d), projection 21 includes a cylindrical sidewall 23 approximately 1.75 inches in diameter and a flattened, generally circular platform 25 formed on the free end of cylindrical sidewall 23.

Circular platform 25 is shaped to include a hole 26 that is dimensioned to fittingly receive a portion of a used pet waste bag, as will be described further below. In the present embodiment, hole 26 is represented as a pair of 1.4 inch linear slots 27-1 and 27-2 that transverse one another in a perpendicular relationship, slots 27 crossing at the approximate midpoint of circular platform to form a small, central, circular aperture. As seen most clearly in FIG. 1(c), the inclusion of slots 27 serves to create four independently flexible fingers 29-1 thru 29-4 in circular platform 25, each finger 29 having a rounded triangular, or wedge-like, configuration. As will be described further in detail below, the plurality of fingers 29 are designed to independently frictionally engage a dog waste bag with enough cumulative force to retain the bag coupled thereto.

Circular platform 25 is also shaped to define four, 0.5 inch wide, radially outwardly extending rectangular tabs 31-1 thru 31-4, tabs 31 being equidistantly spaced apart from one another. A corresponding hole 32 is formed in base 19 beneath each tab 31 for molding purposes, as shown in FIG. 1(d). As will be described further in detail below, tabs 31 are designed to releasably engage second end 15 in order to retain device 11 hooked, or clipped, onto to an object, such as a leash, in a closed clamshell-like configuration.

Second end 15 of device is in the form of an enlarged ring that includes a substantially flat inner surface 15-1 and a substantially flat outer surface 15-2, second end 15 being approximately 2.5 inches in diameter and approximately 0.15 inches in thickness. As seen most clearly in FIG. 1(c), second end 15 is shaped to define a central circular opening 33 that is approximately 1.73 inches in diameter. As can be appreciated, second end 15 is designed to stretch slightly to the extent necessary so that projection 21 can fittingly protrude through opening 33. With projection 21 protruding through opening 33 in second end 15, tabs 31 lie flush against outer surface 15-2 of second end 15 to retain device 11 in its closed configuration, as will be described further below.

Intermediary section 17 is in the form of a narrow connective strip that includes an inner surface 17-1 and an outer surface 17-2, wherein outer surface 17-2 of intermediary section 17 lies in a coplanar relationship with both outer surface 19-2 of base 19 and outer surface 15-2 of second end 15, as seen most clearly in FIG. 1(b). Intermediary section 17 includes a pair of opposing outer sections 35-1 and 35-2 and a narrow vertical fold line 37 disposed therebetween. It should be noted that each of outer sections 35 has a reduced thickness of approximately 0.07 inches and fold line 37 has an even further reduced thickness of 0.05 inches. Consequently, it is to be understood that the reduced thickness of intermediary section 17 renders it more flexible than first and second ends 13 and 15, with the highest degree of bendability in device 11 being situated within fold line 37.

A plurality of spaced apart, horizontal gripping ribs 39 is integrally formed onto inner surface 17-1 of each outer section 35, each gripping rib 39 extending upward from inner surface 17-1 approximately 0.03 inches. As will be described further below, gripping ribs 39 serve to frictionally engage opposing surfaces of the object onto which device 11 is mounted (e.g., a leash) to help retain device 11 fixed in place and thereby prevent sliding.

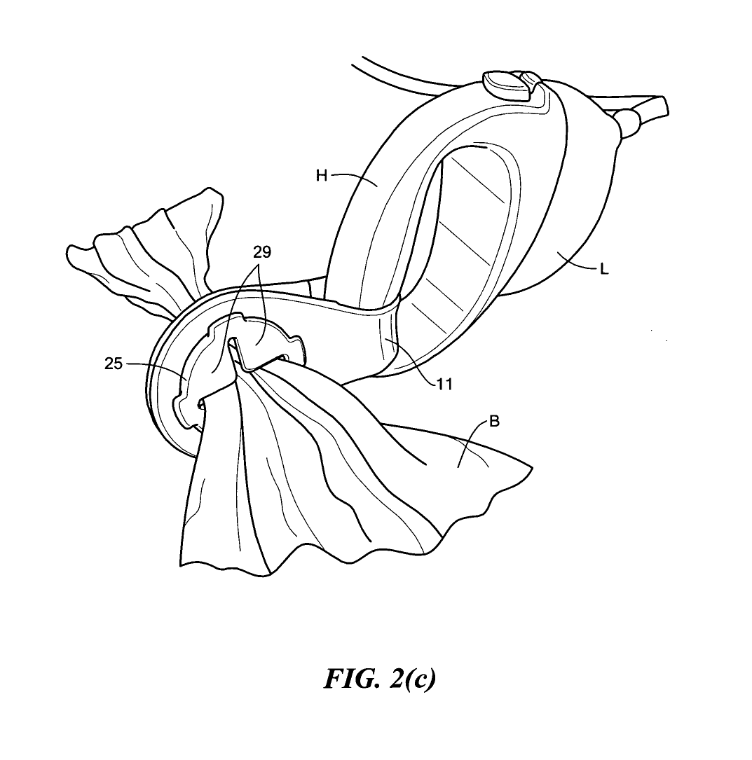

Referring now to FIGS. 2(a)-(c), device 11 is shown at various stages during the process of its mounting on a retractable leash and, in turn, its subsequent use in holding a used dog waste bag in a hands-free manner. Specifically, in connection with the mounting, or clipping, process, device 11 is first disposed in its open position and is inserted through the rigid handle H of a retractable dog leash L, as shown in FIG. 2(a). Device 11 is then folded about itself through fold line 37 so that first and second ends 13 and 15 are drawn towards one another. Second end 15 is then manipulated and stretched to the extent necessary so that projection 21 on first end 13 protrudes through opening 33 in second end 15, with tabs 31 lying flush against outer surface 15-2 of second end 15 to retain device 11 in its closed configuration, as shown in FIG. 2(b).

Having fixedly coupled device 11 to handle H of retractable dog leash L in the manner set forth in detail above, device 11 can then be used to hold a dog waste bag in a hands-free manner. Specifically, an enclosed dog waste bag B in need of proper disposal is pushed by force partially through the plurality of fingers 29 in platform 25. Due to their slightly flexible nature, fingers 29 flex outward to the extent necessary so that central aperture defined therebetween is expanded to a sufficient size that enables dog waste bag B to partially protrude therethrough. Upon withdrawal of the manual insertion force, resilient fingers 29 are naturally biased to return to their original configuration. As fingers 29 return to their original configuration, each finger 29 applies a continuous frictional retention force on bag B, the cumulative force applied by fingers 29 onto bag B being of such magnitude so as to sufficiently retain bag B coupled to device 11, as shown in FIG. 2(c). As can be appreciated, additional used dog waste bags B can be similarly inserted through platform 25 and into engagement with fingers 29 to allow for the simultaneous retention of multiple bags by device 11, which is highly desirable.

It is to be understood that device thereby enables a dog walker to indirectly secure one or more used dog waste bags to the rigid holder of a retractable dog leash. In this capacity, a dog walker is able to hold a leash and one or more dog waste bags with a single hand, thereby enabling the walker to use his/her other hand to perform additional tasks (e.g., operating a cellphone), which is highly desirable. Furthermore, it is to be understood that each of the used dog waste bags are temporarily retained a distance adequately away from both the walker and the dog, which is highly desirable.

It should also be noted that device 11 can be removed from handle H of retractable dog leash L by pulling first and second ends 13 and 15 apart from one another. Once opened, device 11 can be reattached to leash L or any other securable item, as needed.

It should further be understood that device 11 is not limited to securement to the rigid handle of a retractable dog leash. Rather, it is to be understood that device 11 could be similarly mounted onto other types of fixed items, such as a belt loop or alternative style dog leashes, without departing from the spirit of the present invention.

For example, it is to be understood that device 11 could be similarly mounted onto the strap of a standard ribbon style dog leash without departing from the spirit of the present invention. To facilitate in fixedly mounting device 11 onto a more thinly constructed ribbon-style strap leash, an additional clip 111 is provided that is constructed according to the teachings of the present invention.

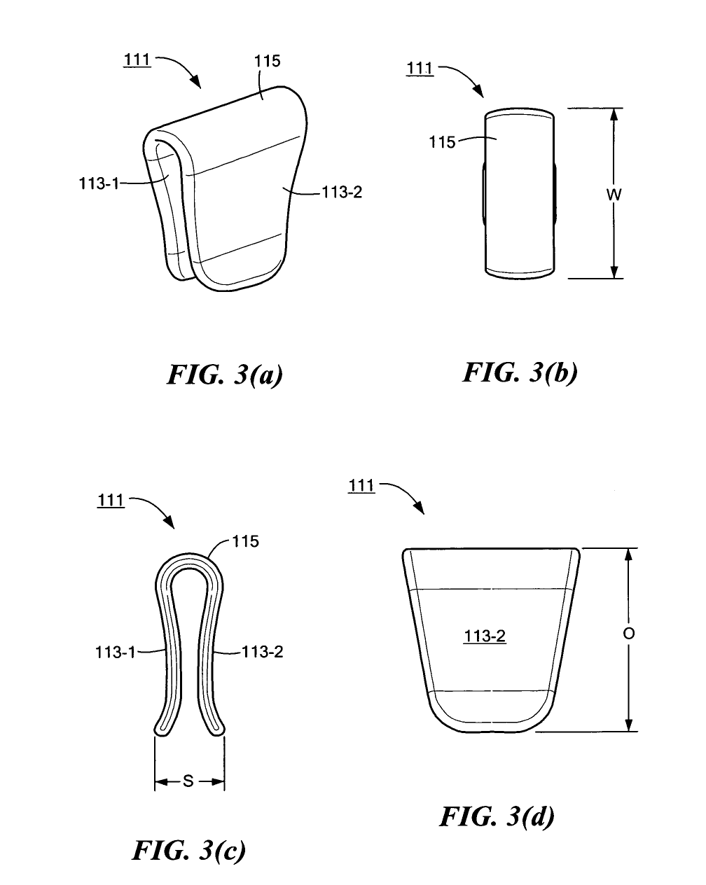

Referring now to FIGS. 3(a)-(d), clip 111 is a unitary, rigid member that is preferably constructed out of Acrylonitrile Butadiene Styrene (ABS) using conventional molding techniques. Clip 111 has a generally inverted U-shaped configuration in transverse in cross-section and includes a pair of opposing, inwardly curved legs 113-1 and 113-2 that are formed onto a common rounded base 115 so as to provide clip 111 with a width W of approximately 1.1 inches and an overall height O of approximately 1.1 inches.

As seen most clearly in FIG. 3(c), legs 113 are separated apart a spacing S of approximately 0.4 inches at their free ends. However, legs 113 have a slight inward curvature, thereby resulting in a reduction in the spacing between legs 113 away from their free ends. As can be appreciated, each leg 113 is capable of limited degree of outward flexion upon receiving a suitable separation force, the resilient, spring-like nature of clip 111 restoring legs 113 to their original configuration upon withdrawal of said force.

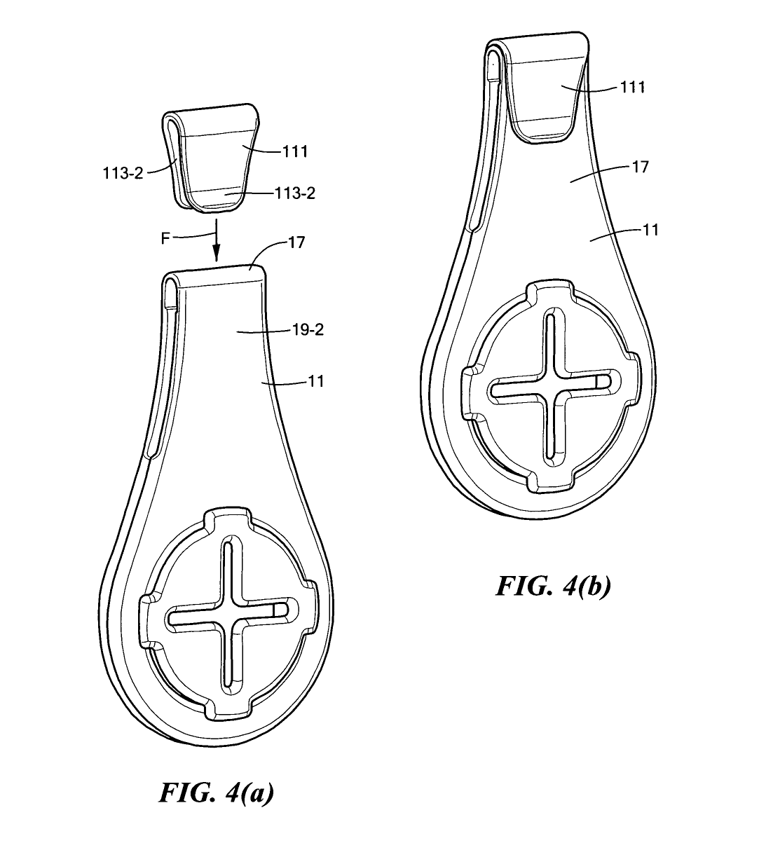

Clip 111 is designed to be releasably mounted onto outer surface 19-2 of intermediary section 17 to facilitate in the fixed securement of device 11 onto a thin strap or other similar dimensioned object, such as a ribbon-style dog leash. Specifically, as shown in FIG. 4(a), clip 111 is positioned directly above device 11 with intermediary section 17 in directly alignment between legs 113-1 and 113-2. Through the application of a suitable downward force (as represented by arrow F in FIG. 4(a)), clip 111 is slid firmly over intermediary section 17 of device 11, as shown in FIG. 4(b).

With clip 111 mounted on device 11 as set forth above, it is to be understood that opposing legs 113 apply a significant inward, spring-like force onto intermediary section 17 of device 11. In turn, the inward force applied by legs 113 serves to clip, or pinch, intermediary section 17 tightly against the strap on which device 11 is mounted, the engagement of gripping ribs 39 against the strap thereby precluding longitudinal slidable displacement, which is highly desirable. As a result, clip 111 serves to fixedly mount device 11 in place on the strap to which it is coupled. Without use of clip 111, it is to be understood that device 11 (as well as any used dog waste bags retained thereby) is more susceptible to slide along the length of the leash in the direction towards the dog attached thereto, which is highly undesirable.

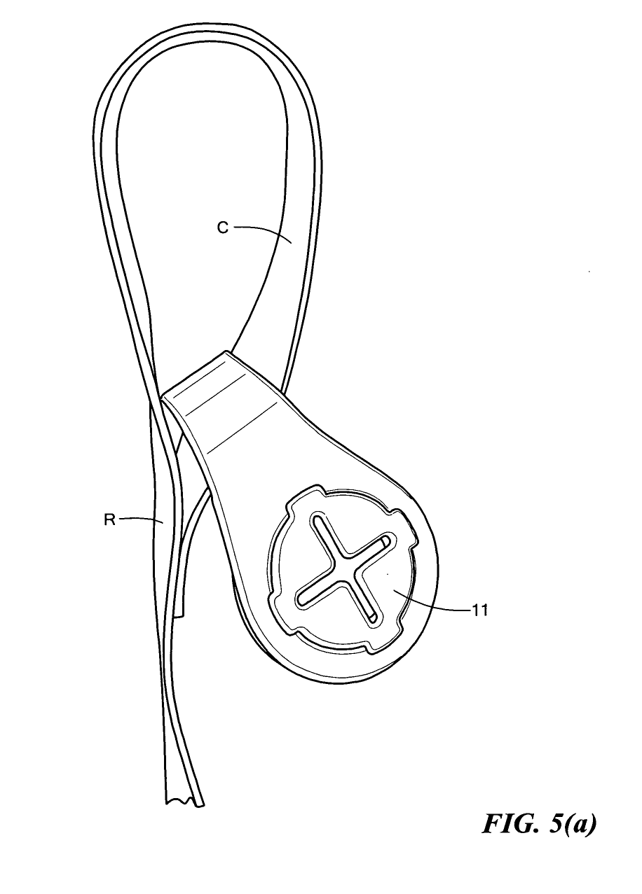

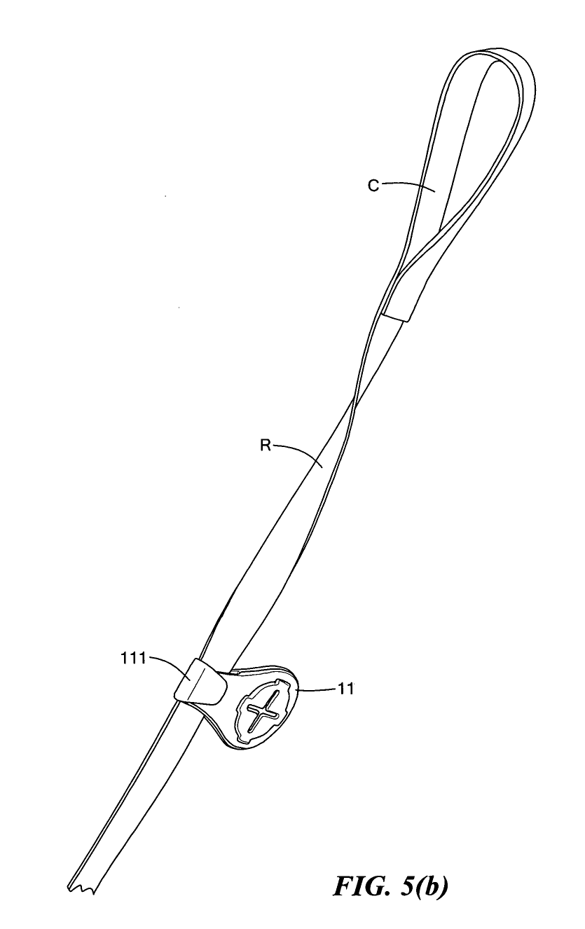

Specifically, referring now to FIG. 5(a), device 11 is being shown mounted on the closed, loop handle C of a traditional ribbon-style leash R. As can be seen, device 11 may be loosely secured to handle C. However, it should be noted that clip 111 enables device 11 to be secured to leash R at any location along its length in a fixed manner. In particular, referring now to FIG. 5(b), clip 111 is being shown securing device 11 at a fixed intermediate location on leash R. In this manner, used dog waste bags retained by device 11 are spaced adequately away from both the leashed dog and the dog walker, which is highly desirable.

The embodiment of the present invention described above is intended to be merely exemplary and those skilled in the art shall be able to make numerous variations and modifications to them without departing from the spirit of the present invention. For example, it should be noted that device 11 is not limited to the particular style of bag retainer 20 shown herein. Rather, it is to be understood that any item capable of releasably retaining a pet waste bag (e.g., a clip, fastener, sharpened pin, tacky strip of material, etc.,) could be used in place of retainer 20 without departing from the spirit of the present invention.

What is claimed is:

1. A device for holding a used dog waste bag, the device comprising:
(a) a first end, the first end including a bag retainer adapted to hold the used dog waste bag,
(b) a second end shaped to define an opening, and
(c) an intermediate section connecting the first and second ends,
(d) wherein the second end is adapted to be releasably secured to the first end to form a closed loop with at least a portion of the bag retainer disposed in alignment within the opening in the second end.

2. The device as claimed in claim 1 wherein the bag retainer at least partially penetrates through the opening in the second end.

3. The device as claimed in claim 1 wherein the bag retainer includes a hole that is adapted to receive the used dog waste bag.

4. The device as claimed in claim 3 wherein the hole is in the form of a pair of transverse slots.

5. The device as claimed in claim 4 wherein the bag retainer includes a plurality of flexible fingers that immediately define the hole, the flexible fingers being adapted to frictionally engage the used dog waste bag when inserted through the hole.

6. The device as claimed in claim 5 wherein the fingers are independently flexible.

7. The device as claimed in claim 1 wherein the bag retainer is in the form of an enlarged projection that includes a cylindrical sidewall and a circular platform formed on the free end of the cylindrical sidewall.

8. The device as claimed in claim 7 wherein the enlarged projection includes at least one outwardly protruding tab that is dimensioned to engage the second end when the device is formed in its closed loop configuration.

9. The device as claimed in claim 8 wherein the second end is in the form of an enlarged ring that is dimensioned to telescopingly slide over the enlarged projection when the device is formed into its closed loop configuration.

10. The device as claimed in claim 9 wherein the intermediate section includes a region that has a thickness less than the thickness of the first and second ends.

11. The device as claimed in claim 10 wherein the intermediate section includes an inner surface, an outer surface and a plurality of gripping ribs formed on its inner surface.

12. The combination of:
(a) a leash, and
(b) a dog waste bag holding device, the device comprising a bag retainer adapted to hold a used dog waste bag, the device being removably securable to the leash.

13. The combination as claimed in claim 12 wherein the device comprises:
(a) a first end that includes the bag retainer for holding the used dog waste bag,
(b) a second end shaped to define an opening, and
(c) an intermediate section connecting the first and second ends,
(d) wherein the second end is adapted to be releasably secured to the first end to form a closed loop with at least a portion of the bag retainer disposed in alignment within the opening in the second end.

14. The combination as claimed in claim 13 wherein the bag retainer at least partially penetrates through the opening in the second end.

15. The combination as claimed in claim 13 wherein the bag retainer includes a hole that is adapted to receive the used dog waste bag.

16. The combination as claimed in claim 15 wherein the hole is in the form of a pair of transverse slots that are immediately defined by a plurality of flexible fingers, the flexible fingers being adapted to frictionally engage the used dog waste bag when inserted through the hole.

17. The combination as claimed in claim 16 wherein the combination further comprises a generally U-shaped clip that is designed to be slid over the intermediate section to further secure the device on the leash.

18. The combination as claimed in claim 17 wherein the clip includes a pair of opposing spring legs that are naturally biased to impart an inward force onto the device to further secure the device on the leash.

19. A method of coupling a used dog waste bag to a leash, the method comprising the steps of:
(a) providing a device for holding a used dog waste bag,
(b) forming the device into a closed loop around a portion of the leash, and
(c) securing the dog waste bag to the device.

20. The method as claimed in claim 19 wherein the device comprises:
(a) a first end, the first end including a bag retainer adapted to hold the used dog waste bag,
(b) a second end shaped to define an opening, and
(c) an intermediate section connecting the first and second ends,
(d) wherein the second end is adapted to be releasably secured to the first end to form the closed loop with at least a portion of the bag retainer disposed in alignment within the opening in the second end.
